(19) United States
(12) Patent Application Publication
(10) Pub. No.: US 2010/0141923 A1
(43) Pub. Date: Jun. 10, 2010

(54) STAGE APPARATUS AND ALIGNER

(75) Inventors: Youichi Motomura, Kitakyushu-shi (JP); Toshiyuki Kono, Kitakyushu-shi (JP); Keiichi Tanaka, Saitama-shi (JP)

Correspondence Address: SUGHRUE-265550, 2100 PENNSYLVANIA AVE. NW, WASHINGTON, DC, 20037-3213, US

(73) Assignees: KABUSHIKI KAISHA YASKAWA DENKI, Kitakyushu-shi (JP); NIKON CORPORATION, Tokyo (JP)

(21) Appl. No.: 12/525,084

(22) PCT Filed: Jan. 25, 2008
(86) PCT No.: PCT/JP2008/051099

§ 371 Date: Feb. 4, 2010

(30) Foreign Application Priority Data
Jan. 30, 2007 (JP) 2007-019616

(51) Int. Cl. G03B 27/58

(52) U.S. Cl. 355/72

(57) ABSTRACT

There is provided a stage apparatus at low cost by constituting a counter mass constituting a movable portion of the stage apparatus at low cost.

In a stage apparatus used for fabrication or for inspection, by fastening two pieces of first frames (1) and two pieces of second frames (2) by bolts in a positional relationship of making the first frames (1) and the second frames (2) respectively opposed to each other, a counter mass constituting a movable portion of the stage apparatus is constituted, by attaching ceramic-made air pads (4) to air pad attaching faces respectively formed at upper faces and lower faces of two pieces of the first frames (1) on both sides in a length direction, four air bearings are constituted at four corners of the counter mass of the stage apparatus, and the counter mass is floated up by the four air bearings.

### TECHNICAL FIELD

The present invention relates to a stage apparatus and an aligner mainly applied to semiconductor fabrication apparatus or inspection apparatus.

### RELATED ART

In a lithography step of fabricating a semiconductor element, a liquid crystal display element or the like, there has been comparatively frequently used a scanning type aligner of a step-and-scan system (so-to-speak scanning stepper) or the like in which a pattern of a reticle is transcribed onto a wafer by way of a projection optical system while synchronizingly moving a mask or a reticle (hereinafter, generally referred to as “reticle”) and a photosensitive object of a wafer or a glass plate or the like (hereinafter, generally referred to as “wafer”) in a predetermined scanning direction (scan direction).

The scanning type aligner can expose a large field by a smaller projection optical system in comparison with an apparatus of a stationary exposure type of a stepper or the like. Therefore, there are advantages that not only fabrication of a projection optical system is easy, but a high throughput can be expected by a reduction in a shot number by exposure of a large field, an averaging effect is achieved by relatively scanning a reticle and a wafer relative to a projection optical system, a promotion in a distortion or a focal depth can be expected and the like.

In a scanning type aligner, in addition to a wafer side, also on a reticle side, a drive apparatus of driving a reticle is needed. In a scanning type aligner in recent times, as a drive apparatus on a reticle side, there is a reticle stage apparatus provided with a reticle stage floatingly supported above a reticle level block by an air bearing or the like, and driven in a predetermined stroke range at least with regard to a scanning direction by a linear motor, and a counter mass mechanism having a counter mass (weight member) moved in a direction opposed to that of the reticle stage along a stator (linear guide) of the linear motor extended, for example, in the scanning direction of the reticle stage substantially complying with a law of conservation of momentum by receiving a reaction force of a drive force of the reticle stage.

According to the apparatus of this kind, it can be restrained as much as possible that a reaction force generated at the stator of the linear motor constitutes a factor of vibration of the reticle stage level block or a factor of an attitude change thereof by moving the above-described counter mass.

Further, positioning of the reticle is carried out by constituting a fine movement stage above the counter mass, mounting the reticle above the fine movement stage, and driving a rough movement stage and the fine movement stage by the motor, and a circuit pattern formed at the reticle is transcribed onto a glass substrate.

According to the apparatus, transcription onto the wafer is carried out by using the reticle held above the reticle stage, and therefore, it is necessary to constitute a center portion of the counter mass to pass a pattern image of the reticle, it is necessary to form an opening at the center portion of the counter mass for enabling to pass the pattern image of the reticle, and a shape of the counter mass becomes a shape of a frame. (Refer to Patent Reference 1)

Further, in order to realize positioning with a high accuracy of the counter mass, with regard to floating up the counter mass on air, it is effective to ensure a property of an air bearing by working a pad portion with a high accuracy and constituting the pad portion highly rigidly by forming the pad portion of the air bearing by a ceramic material.

Further, in order to achieve downsizing of the apparatus, with regard to the air bearing of the counter mass, it is preferable to constitute the air bearing of the counter mass by a minimum space in a range of capable of floating up the counter mass on air.

Therefore, a constitution of floating up the counter mass by providing the four air bearing at four corners of the counter mass is effective. According to the constitution, an outer shape of the apparatus can be constituted to be small.

When the counter mass is fabricated based on the above-described constitution, there is a method of fabricating the counter mass by working the ceramic material.

### Patent Reference 1: JP-A-2004-349285

### DISCLOSURE OF THE INVENTION

According to the apparatus, when the counter mass is fabricated by the ceramic material, there poses a problem that a fabrication cost becomes high with regard to fabrication of the counter mass since the counter mass is constituted by the frame shape, and working the material into the counter mass is needed.

The invention has been carried out in view of the problem and it is an object thereof to provide a stage apparatus capable of being constituted at low cost and an aligner using the same.

In order to resolve the above-described problem, according to the first aspect of the invention, there is provided a stage apparatus used for fabrication or for inspection, including:

two pieces of first frames of metal members, and

two pieces of second frames of metal members, wherein

a counter mass constituting a movable portion of the stage apparatus is constituted by fastening two pieces of the first frames and two pieces of the second frames in a positional relationship of making the first frames and the second frames respectively opposed to each other by bolts.

Further, according to the second aspect of the invention, there is provided the stage apparatus of the first aspect, wherein

four air bearings are constituted at four corners of the counter mass of the stage apparatus by attaching ceramic-made air pads to air pad attaching faces respectively formed at upper faces and lower faces of two pieces of the first frames on both sides in a length direction thereof, and

the counter mass is floated up by the four air bearings.

Further, according to the third aspect of the invention, there is provided the stage apparatus of the second aspect, wherein

a highly accurate flatness is ensured by simultaneously working the air pad attaching faces of the first frames.

Further, according to the fourth aspect of the invention, there is provided the stage apparatus of the second aspect, wherein

fastening of the first frame and the second frame is constituted by fastening by the bolt in a direction orthogonal to a pad load direction.

Further, according to the fifth aspect of the invention, there is provided the stage apparatus of the second aspect, wherein

after attaching the ceramic-made air pads respectively to the respective air pad attaching faces formed at the first frames, final polishing is carried out for the respective ceramic-made air pads.

Further, according to the sixth aspect of the invention, there is provided an exposure apparatus including:

a light source,

an optical system of converging light from the light source, and

a stage apparatus mounted with a substrate, wherein

a counter mass of the stage apparatus driven in noncontact is constituted by a material including a metal material, and

the counter mass includes an air pad made of a ceramic.

Further, according to the seventh aspect of the invention, there is provided the exposure apparatus of the sixth aspect, wherein

the air pads are arranged at least four portions of the counter mass.

Further, according to the eighth aspect of the invention, there is provided the exposure apparatus of the sixth or seventh aspect, wherein

the air pads support an upper face and a lower face of the counter mass.

According to the invention, a principal portion of the counter mass is constituted by a metal material, and therefore, a table apparatus can be constituted at low cost.

Further, the ceramic-made pad of a necessary minimum volume is provided at the pad of the air bearing, and therefore, the air bearing can be constituted at low cost while ensuring a property of floating up the counter mass by the air bearing.

Further, although the pad portion of the air bearing is generally constituted by a small clearance, and therefore, the pad portion is liable to be damaged, when the pad portion is damaged by an unprepared operation, an erroneous operation of the apparatus or the like, only the damaged pad portion can be interchanged.

Further, the first frame is constituted to provide two portions of the pad attaching faces, and therefore, a highly accurate flatness can be ensured with regard to two portions of the pad attaching faces by simultaneous working, an amount of final polishing to a total of eight portions of the ceramic pads can be minimized, also steps of integrating and working become inconsiderable, and therefore, the stage apparatus can be constituted at low cost.

Further, at step of fastening, the pad attaching faces are fastened on the level block in a state of being installed on the same face, further, an amount of deforming the frame by bolt fastening is generated only in a direction orthogonal to the pad attaching faces, and therefore, in fastening, the pad attaching face of the first frame can be integrated with a high accuracy in the flatness of the pad attaching face.

Further, polishing of the four ceramic pads can be minimized, and the stage apparatus can be constituted at low cost.

Further, by using the counter mass of the above-described constitution, the property of floating up the counter mass by the air bearing can be ensured and the aligner can be provided at low cost.

### BRIEF DESCRIPTION OF THE DRAWINGS

FIG. 1 illustrates views of a procedure of constituting a counter mass of a stage apparatus showing the First embodiment of the invention.

FIG. 2 is a perspective view showing an outlook of a stage apparatus according to the invention.

FIG. 3 is a view of an aligner including a stage apparatus according to the First Embodiment.

### DESCRIPTION OF REFERENCE NUMERALS AND SIGNS

1 first frame
2 second frame
3 pad attaching face
4 ceramic pad
5 stage apparatus
6 reticle table
7 reticle stage level block
8 counter mass
9 air guide
10 Y axis linear motor
11 reticle table fine movement mechanism
12 air pad
13 air guide frame
14 Y axis trim motor
15 X axis trim motor
31 aligner
32 vacuum chamber
33 light source
34 stage apparatus
35 mask
36 wafer
37 wafer stage
38 converging mirror
39, 42 concave mirrors
40, 41 convex mirrors

### BEST MODE FOR CARRYING OUT THE INVENTION

The embodiments of the invention will be explained in reference to the drawings as follows.

### Embodiment 1

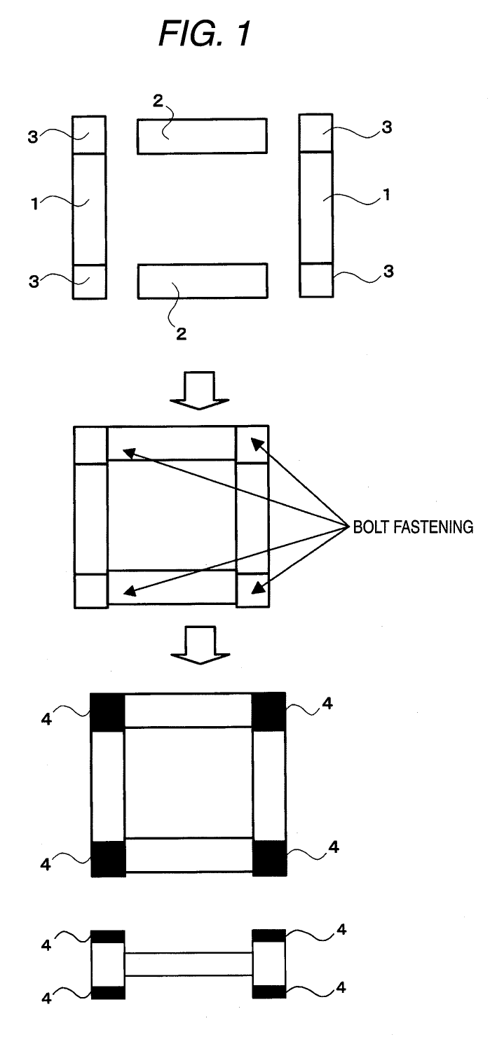

FIG. 1 illustrates views of a procedure of constituting a counter mass of a stage apparatus of the invention.

In the drawings, two pieces of first frames 1 and 2 pieces of second frames 2 are metal members, and a frame portion of a counter mass 8 is constituted by bolt fastening thereof. Further, ceramic pads 4 are attached to pad attaching faces 3 formed at a total of eight portions of upper faces and lower faces on both sides of the first frame 1.

Next, the constituting procedure will be explained. First, the pad attaching faces 3 at two portions of the first frame 1 ensure a highly accurate flatness by simultaneous working.

Next, fastening of the first frame 1 and the second frame 2 is constituted by bolt fastening in a direction orthogonal to a pad load direction.

Further, after attaching the ceramic pads 4 to the pad attaching faces 3 formed at the total of eight portions of the upper faces and the lower faces on the both sides of the first frame 1, final polishing is carried out at four portions of the ceramic pads 4, and the respective four portions of the upper faces and the lower faces of the ceramic pads 4 are worked into the same flat faces.

Portions of the invention which differ from the background art reside in constituting principal portions of a moving table by metal members and constituting an air bearing portion by using a necessary minimum ceramic pad.

Next, an explanation will be given of an apparatus of applying the invention.

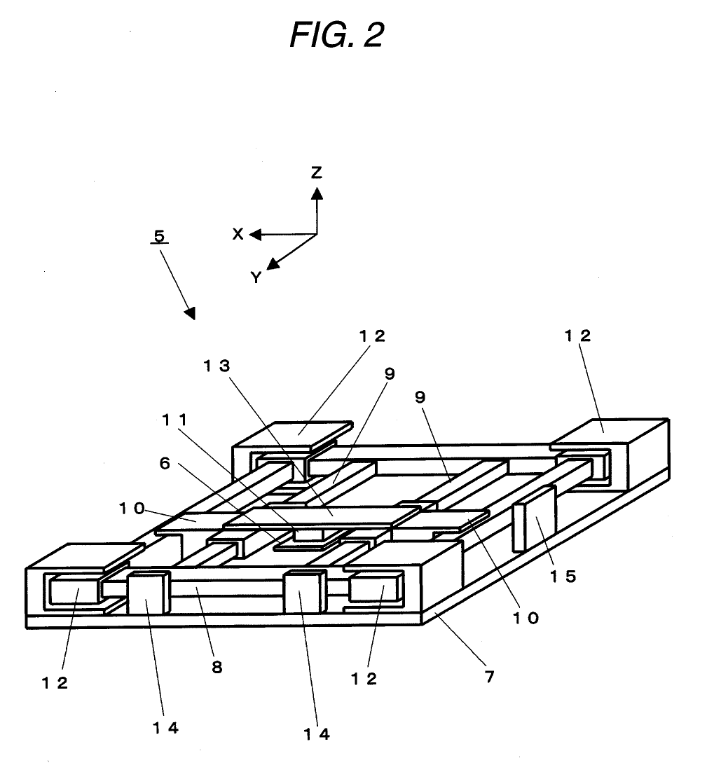

FIG. 2 shows an outline constitution of a stage apparatus 5 according to the invention. The stage apparatus 5 is a scanning type apparatus of a step-and-scan system, that is, a so-to-speak scanning stepper (also referred to as scanner).

The stage apparatus 5 is provided with a projection optical system unit, and in the following, a direction of an optical axis of a projection optical system constituting the projection optical system is defined as a Z axis direction, a direction of relatively scanning a reticle constituting a mask (and an object) and a wafer constituting a photosensitive object within a face orthogonal thereto is defined as a Y axis direction, and a direction orthogonal to the Z axis and the Y axis is defined as an X axis direction.

The stage apparatus 5 is provided with a reticle table 6 of mounting a reticle formed with a desired pattern and a sensitive substrate stage of mounting a sensitive substrate of transcribing a pattern, a projection optical system of projecting to focus an energy line passing an original edition onto the sensitive substrate, and is used for carrying out exposure while synchronizingly and continuously moving (synchronizing scan) the two stages in a certain direction (Y direction).

Further, a kind of the energy line is not limited to EUV light but may be ultraviolet light, an electron beam line, an ion beam or the like. Further, a type of exposure is not particularly limited but may be a reduction projection exposure or an equal magnification proximity transcription.

As shown by FIG. 2, the stage apparatus 5 is a stage apparatus of moving and positioning the stage in a main scanning direction (Y direction) while floating up the stage, and is provided with a reticle stage level block 7 as a level block, the counter mass 8 of the frame-like member arranged above the reticle stage level block 7, two pieces of air guides 9 extended in parallel with the Y direction and reticle table Y axis linear motors 10, the reticle table 6 of holding a reticle and a reticle table fine movement mechanism 11.

The reticle stage level block 7 is supported substantially horizontally by a support member, not illustrated. As shown by FIG. 2, the reticle stage level block 7 is constituted by a member substantially in a plate-like shape, and an opening for passing illumination light (for ensuring an optical path) is formed to penetrate in the Z axis direction at substantially a center thereof.

The counter mass 8 is provided with two side portions along the Y direction and two side portions along the X direction. Air pads 12 are constituted at four corners of the counter mass 8 and the counter mass 8 is floatingly supported by way of a clearance of several μm by supplying a pressurized gas from a gas supply apparatus, not illustrated, to a gas supply inlet of a fixed side air pad arranged at the reticle stage level block 7, and exhausting the gas from an exhaust port. Further, the exhaust port is connected to a vacuum pump, not illustrated, by way of an exhaust pipe, not illustrated, and the gas is exhausted by the vacuum pump. The exhaust port formed at an inner portion of an exhaust groove is connected to the vacuum pump, not illustrated, by way of an exhaust pipe line and the exhaust pipe.

In this way, gas static pressure bearings of a differential exhaust type of floatingly supporting the counter mass 8 to an upper side of the reticle stage level block 7 are constituted by the air pads 12 at the four corners of the counter mass 8.

The two air guides 9 in parallel with each other along the Y direction are hung between the two side portions of the counter mass frame. The stage is made to be able to slide in the Y direction along the air guides 9. The counter mass 8 is made to function as a counter mass when the reticle stage is driven by the Y axis linear motor 10 arranged between a movable element of the air guide 9 and the counter mass 8.

The gas supply inlet of the air guide 9 is connected to the gas supply apparatus, not illustrated, of supplying the gas by way of a gas supply pipe, and by supplying the pressurized gas to the air guide 9, a Y axis movable portion is floatingly supported in noncontact by way of the clearance of several μm. Further, the exhaust port is connected to the vacuum pump, not illustrated, by way of the exhaust pipe, not illustrated, and is exhausted by the vacuum pump.

The Y axis linear motors 10 are respectively arranged between the movable elements of two pieces of the air guides 9 and the counter mass 8, thereby, the reticle stage and the counter mass 8 are constituted to be driven in the Y axis direction relative to each other.

The reticle table 6 is arranged at an air guide frame of fixing two pieces of the air guides 9 of a counter mass frame by way of the reticle fine movement mechanism (a unit of an air bearing and a motor) 11. Thereby, a fine stroke is made to be able to carry out in the X axis, the Y axis, the Z axis directions.

Further, reflection mirrors are provided at side faces of the reticle table 6 at positions in the X direction and the Y direction opposed to interferometers attached at outside of the stage apparatus, a position of the reticle table 6 is highly accurately monitored by laser interferometers, not illustrated, and the reticle table 6 is controlled by detecting a position and an attitude of the reticle table 6. The reticle is held by the reticle table 6. The reticle table 6 is provided with a reticle holding mechanism using an electrostatic chuck.

Further, the reticle holding mechanism is not limited to the electrostatic chuck but there is also a method of mechanically constituting the reticle holding mechanism by using a reticle support member and an urging mechanism.

The counter mass 8 is floated up above the reticle stage level block 7, and therefore, the counter mass 8 is moved by a reaction force operation or the like when the reticle table 6 is driven, and therefore, it is necessary to control the position. Hence, trim motors are arranged at an X side face and a Y side face of the counter mass 8 between the reticle stage level block 7 and the counter mass 8. In this embodiment, two pieces of the Y axis trim motors 14 and one piece of the X axis trim motor 15 are used, thereby, the counter mass 8 is driven in the X direction and the Y direction and positioning in a θz direction can be carried out and a fine adjustment of the position of the counter mass 8 is carried out.

According to the embodiment, an exposure operation of the step-and-scan system is carried out by alternate scan as described above, and at this occasion, the reticle stage constituted by the air guide 9, the air guide frame, the reticle table 6, and the reticle table fine movement mechanism 11 carries out a reciprocal movement with regard to a scanning direction within a predetermined stroke range.

A reaction force of a drive force in the reciprocal movement of the reticle stage is canceled by a movement of the counter mass 8. An explanation will be given of the point as follows.

When the reticle stage is driven in the Y axis direction by the Y axis linear motor 10, a reaction force operated between the movable element and the stator of the Y axis linear motor 10 is operated to the counter mass 8. In this case, by an operation of the reaction force, the counter mass 8 is moved by a distance substantially complying with the law of conservation of momentum in a direction in accordance with a resultant force of the reaction force, thereby, the reaction force is almost absorbed. Further, two pieces of the Y axis linear motors 10 arranged in parallel with each other in the Y axis direction are driven in synchronism with each other.

However, when the reticle stage is driven, there is a case in which the movement of the counter mass 8 receiving the reaction force of the drive force does not completely comply with the law of conservation of momentum.

This is because in an actual stage apparatus, there is also an influence of a friction force between the reticle stage and a surrounding gas or the like, further, other factor of hampering establishment of the law of conservation of momentum is present.

Therefore, for example, when attention is paid to the Y axis direction which is a scanning direction in which the reticle stage is moved by a large stroke, there is a case in which a position of the counter mass delicately differs between those at a time point of starting the movement of one reciprocation of the reticle stage and a time point of finishing the movement. Therefore, in accordance with repeatedly carrying out the reciprocal movement of the reticle stage in the scanning direction (Y axis direction), the counter mass 8 is gradually drifted from an initial position. (A deviation in a gravitational center of a system including the reticle stage and the counter mass is brought about, and there is a possibility that an unnegligible uneven load is operated to the reticle stage level block 7 by the deviation in the gravitational center.)

Hence, according to the embodiment, the position of the counter mass 8 is adjusted as follows. During a time period of the reciprocal movement of the counter mass 8, position information in the Y axis direction of the reticle stage is detected by the interferometer attached to outside, and the counter mass 8 is recovered to a predetermined reference position from the position information by the Y axis trim motor 14, the X axis trim motor 15.

In the stage apparatus 5 described above, the principal portion of the counter mass 8 is constituted by the metal member, the air bearing portion is constituted by using the necessary minimum ceramic pads 4 shown in FIG. 1, and therefore, the stage apparatus can be provided at low cost.

### Embodiment 2

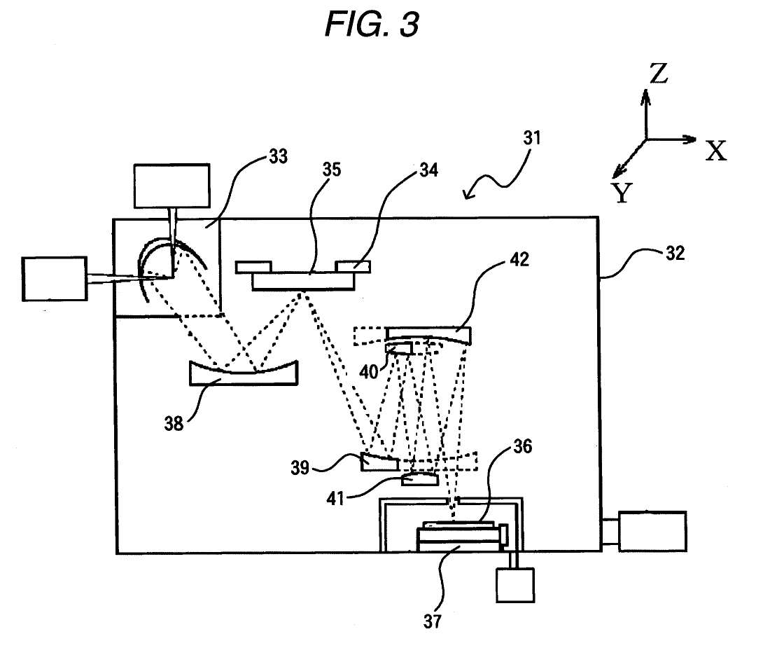

FIG. 3 is a view of an exposure apparatus including the stage apparatus according to Embodiment 1 of the invention.

Numeral 31 designates an aligner, and numeral 32 designates a vacuum chamber containing a stage apparatus 34. Numeral 33 designates a light source, which emits EUV light of a wavelength of 13.5 through 400 nm. Numeral 34 designates the stage apparatus explained in Embodiment 1. A mask 35 is attached to a lower face of the stage apparatus 34. A pattern of a circuit formed at the wafer 36 is drawn at the mask 35. The wafer 36 is mounted to a wafer stage 37.

The EUV light emitted from the light source 33 is converged by a converging mirror 38, reflected by the mask 35, repeats reflection in an order of a concave mirror 39, convex mirrors 40, 41, a concave mirror 42, and reaches the wafer 36. Further, the stage apparatus 34 and the wafer stage 37 are moved by relatively matching phases thereof to form a reduction image of a circuit pattern drawn on the mask 35 on the wafer 36 at a surface of the wafer 36.

As the stage apparatus 34, by using the stage apparatus according to the invention, an aligner at low cost is provided.

Although a detailed explanation has been given of the invention in accordance with the particular embodiments as described above, it is apparent to the skilled person that the invention can variously be changed and modified without deviating from the spirit and the range of the invention. Further, the application is based on Japanese Patent Application (Japanese Patent Application No. 2007-19616) filed on Jan. 30, 2007, a total thereof is applied by citation.

Further, all of references cited here are incorporated as a total.

### INDUSTRIAL APPLICABILITY

The invention is not limited to an aligner but is applicable to use of other precision machine or the like so far as the apparatus is an apparatus including a counter mass moved above a level block by an operation of a reaction of a drive force of a stage relative to the stage reciprocally moved above the level block within a predetermined stroke range at least with regard to a predetermined one axis direction.

1. A stage apparatus used for fabrication or for inspection comprising:
two pieces of first frames of metal members, and
two pieces of second frames of metal members, wherein
a counter mass constituting a movable portion of the stage apparatus is constituted by fastening two pieces of the first frames and two pieces of the second frames in a positional relationship of making the first frames and the second frames respectively opposed to each other by bolts.

2. The stage apparatus of claim 1, wherein
four air bearings are constituted at four corners of the counter mass of the stage apparatus by attaching ceramic-made air pads to air pad attaching faces respectively formed at upper faces and lower faces of two pieces of the first frames on both sides in a length direction thereof, and
the counter mass is floated up by the four air bearings.

3. The stage apparatus of claim 2, wherein
a highly accurate flatness is ensured by simultaneously working the air pad attaching faces of the first frames.

4. The stage apparatus of claim 2, wherein
fastening of the first frame and the second frame is constituted by fastening by the bolt in a direction orthogonal to a pad load direction.

5. The stage apparatus of claim 2, wherein
after attaching the ceramic-made air pads respectively to the respective air pad attaching faces formed at the first frames, final polishing is carried out for the respective ceramic-made air pads.

6. An exposure apparatus comprising:
a light source,
an optical system of converging light from the light source, and
a stage apparatus mounted with a substrate, wherein
a counter mass of the stage apparatus driven in noncontact is constituted by a material including a metal material, and
the counter mass includes an air pad made of a ceramic.

7. The exposure apparatus of claim 6, wherein
the air pads are arranged at least four portions of the counter mass.

8. The exposure apparatus of claim 6, wherein
the air pads support an upper face and a lower face of the counter mass.
